(19) United States
(12) Patent Application Publication
(10) Pub. No.: US 2026/0252372 A1
(43) Pub. Date: Aug. 27, 2026

(54) SERVER INTERNAL DATA TRANSFER DEVICE, DATA TRANSFER SYSTEM, SERVER INTERNAL DATA TRANSFER METHOD, AND PROGRAM

(71) Applicant: NTT, Inc., Tokyo (JP)

(72) Inventors: Kei FUJIMOTO, Musashino-shi, Tokyo (JP); Ko NATORI, Musashino-shi, Tokyo (JP)

(21) Appl. No.: 18/992,382

(22) PCT Filed: Jul. 11, 2022
(86) PCT No.: PCT/JP2022/027326

§ 371 Date: Jan. 8, 2025

(51) Int. Cl. G06F 9/455

(52) U.S. Cl. CPC G06F 9/45558; G06F 2009/45579; G06F 2009/45595

(57) ABSTRACT

An operating system (OS) includes a kernel, and a hardware (HW) interrupt processing unit capable of processing arrival of data from an interface unit in a polling mode or an interrupt mode, and an on-server data transmission controller includes: a packet arrival monitoring unit that starts up a thread that monitors arrival of a packet using a polling model in the kernel; and a transmission processing unit that, when the packet arrival monitoring unit detects the arrival of the packet, notifies a protocol processing unit in an application of presence of an arriving packet without using a kernel protocol stack.

### TECHNICAL FIELD

The present invention relates to an on-server data transmission controller, a data transmission system, an on server data transmission method, and a program.

### BACKGROUND ART

Under the background of advance in virtualization technology achieved through network functions virtualization (NFV), and the like, systems are being constructed and operated for each of services. Further, a mode called service function chaining (SFC) is becoming a mainstream, in which, based on the above-described mode of constructing a system for each service, a service function is divided into units of reusable modules and the divided units are operated respectively on independent virtual machine (VM: virtual machine, container, etc.) environments, and thereby the service functions are used as needed like components, and operability is improved.

A hypervisor environment constructed by Linux (registered trademark) and a kernel-based virtual machine (KVM) is well known as a technology for constructing a virtual machine. In this environment, a host operating system (OS, an OS installed on a physical server is called a host OS) in which a KVM module is incorporated operates as a hypervisor in a memory area called a kernel space different from a user space. In this environment, the virtual machine operates in the user space, and a guest OS (an OS installed on a virtual machine is called a guest OS) operates in the virtual machine.

Unlike the physical server in which the host OS operates, in the virtual machine in which the guest OS operates, all hardware (HW) including network devices (typified by Ethernet (registered trademark) card device, and the like) is operated with register control, which is needed for interrupt processing from the HW to the guest OS, and writing from the guest OS to the HW. In such register control, performance is generally lower than that in the host OS environment because notifications and processing that would been originally executed by physical hardware are emulated artificially by software.

As a measure for addressing this performance degradation, there is a technology for reducing HW emulation and improving communication performance and versatility, in particular, from a guest OS to a host OS or an external process existing outside the own virtual machine, and using a high-speed and unified interface. As this technology, an abstraction technology of a device called virtio, that is, paravirtualization technology, has been developed and already embedded in many general-purpose OSs, such as Linux (registered trademark) and FreeBSD (registered trademark), and is currently being utilized.

Regarding data input/output such as console, file input/output, and network communication, virtio defines data exchange using a queue designed with a ring buffer as a unidirectional transmission transport for transmission data using queue operations. Then, by using the virtio queue specifications and preparing the number and size of queues suitable for each device when the guest OS is activated, communication between the guest OS and a device outside of the virtual machine can be achieved simply by using queue operations without executing hardware emulation.

### Packet Transmission Using Polling Model (Example of DPDK)

The method of connecting and linking a plurality of virtual machines is called Inter-VM Communication, and large-scale environments such as data centers have used virtual switches as standard for connections between VMs. However, Because this method involves a large communication delay, new faster methods have been proposed. For example, a method called single root I/O virtualization (SR-IOV) using special hardware, a method performed with software using Intel data plane development kit (Intel DPDK, hereinafter referred to as DPDK), which is a high-speed packet processing library, and the like have been proposed (see NPL 1).

DPDK is a framework for performing control of a network interface card (NIC), which was conventionally performed by a Linux kernel (registered trademark), in a user space. The biggest difference from the processing in the Linux kernel is that DPDK has a polling-based reception mechanism called a pull mode driver (PMD). Normally, in the Linux kernel, when data arrives at the NIC, an interrupt occurs, and this triggers the execution of reception processing. On the other hand, in the PMD, a dedicated thread continuously performs data arrival check and reception processing. DPDK is able to perform a high-speed packet processing by eliminating the overhead of context switches, interrupts, and the like. DPDK significantly increases packet processing performance and throughput, and makes it possible to secure more time for data plane application processing.

DPDK exclusively uses computer resources such as a central processing unit (CPU) and a NIC. For this reason, it is difficult to apply it to an application such as SFC, which flexibly reconnects on a module basis. There is a soft patch panel (SPP), which is an application for mitigating this problem. SPP omits packet copying at the virtualization layer by using a configuration in which shared memory is prepared between VMs and each VM can directly reference the same memory space. Further, the transmission and reception of packets between the physical NIC and the shared memory is achieved at a high speed by using the DPDK. In the SPP, the input destination and output destination of a packet can be changed by software by controlling the reference destination of the memory exchange of each VM. This process allows the SPP to achieve dynamic connection switching between VMs or between a VM and a physical NIC.

FIG. 10 is a diagram illustrating packet transmission performed using a polling model in an Open vSwitch with DPDK (OvS-DPDK) configuration.

As shown in FIG. 10, a host OS 20 includes an OvS-DPDK 70, which is software for packet processing, and the OvS-DPDK 70 includes a vhost-user 71, which is a functional unit for connecting to a virtual machine (here, VM 1), and a dpdk (PMD) 72, which is a functional unit for connecting to a NIC (DPDK) 13 (physical NIC).

Also, a packet processing APL 1A includes a dpdk (PMD) 2, which is a functional unit that performs polling in a guest OS 50 section. That is, the packet processing APL 1A is an APL obtained by equipping a packet processing APL 1 of FIG. 10 with the dpdk (PMD) 2 and modifying the packet processing APL 1.

The packet transmission by the polling model enables path operation with a GUI in the SPP in which packet copying between the host OS 20 and the guest OS 50 is performed at high speed with zero copy via the shared memory, which is an extension of DPDK.

[Rx-side Packet Processing using New API (NAPI)] FIG. 11 is a schematic diagram of Rx-side packet processing using a new API (NAPI) implemented in Linux kernel 2.5/2.6 or below.

As shown in FIG. 11, the new API (NAPI) executes the packet processing APL 1 placed in a user space 60 usable by a user on a server including an OS 70 (for example, a host OS), and performs packet transmission between the NIC 13 of HW 10 connected to the OS 70 and the packet processing APL 1.

The OS 70 includes a kernel 71, a ring buffer 72, and a driver 73, and the kernel 71 includes a protocol processing unit 74.

The kernel 71 performs a function of a backbone portion of the OS 70 (for example, a host OS), and manages monitoring of hardware and execution states of programs on a per-process basis. Here, the kernel 71 responds to a request from the packet processing APL 1 and transmits the request from the HW 10 to the packet processing APL 1. In response to the request from the packet processing APL 1, the kernel 71 performs processing via a system call (a “user program operating in non-privileged mode” requests processing to a “kernel operating in privileged mode”).

The kernel 71 transmits a packet to the packet processing APL 1 via a socket 75. The kernel 71 receives a packet from the packet processing APL 1 via the socket 75.

The ring buffer 72 is managed by the kernel 71 and is located in a memory space in the server. The ring buffer 72 is a buffer of a fixed size for storing a message output by the kernel 71 as a log, and is overwritten from the beginning when the upper limit size is exceeded.

The driver 73 is a device driver for monitoring hardware with the kernel 71. The driver 73 varies depending on the kernel 71, and becomes a different driver when the created (built) kernel source is changed. In this case, the driver source should be obtained, and the driver should be rebuilt to create the driver on the OS using the driver.

The protocol processing unit 74 performs protocol processing of L2 (data link layer)/L3 (network layer)/L4 (transport layer), which are defined by an open systems interconnection (OSI) reference model.

The socket 75 is an interface for the kernel 71 to perform inter-process communication. The socket 75 has a socket buffer and suppresses data copy processing from frequently occurring. The flow up to establishment of communication via the socket 75 is as follows. 1) Create a socket file through which the server side receives a client. 2) Name the reception socket file. 3) Create a socket queue. 4) Receive the first connection from a client that is in the socket queue. 5) Create a socket file on the client side. 6) Send a connection request from the client side to the server. 7) On the server side, create a connection socket file separately from the reception socket file. As a result of establishing communication, the packet processing APL 1 is able to call a system call such as read() and write()to the kernel 71.

In the above-described configuration, the kernel 71 receives a notification of packet arrival from the NIC 13 by a hardware interrupt (hardIRQ), and schedules a software interrupt (softIRQ) for packet processing.

When a packet arrives, the New API (NAPI) implemented by Linux kernel Because 2.5/2.6 performs packet processing by a software interrupt (softIRQ) after a hardware interrupt (hardIRQ). As shown in FIG. 11, in packet transmission performed using the interrupt model, a packet is transmitted through interrupt processing (see reference sign c in FIG. 11), which causes a wait for interrupt processing and increases the delay in packet transmission.

The outline of NAPI Rx-side packet processing is described below.

### Rx-Side Packet Processing Configuration Using New API (NAPI)

FIG. 12 is a diagram illustrating an outline of Rx-side packet processing using a new API (NAPI) at a position surrounded by a broken line in FIG. 11.

### Device Driver

As shown in FIG. 12, in the device driver, a NIC 13 (physical NIC), which is a network interface card, a hardIRQ 81, which is a handler that is called upon generation of a processing request from the NIC 13 and executes the requested processing (hardware interrupt), and a netif_rx 82, which is a processing functional unit of a software interrupt, are arranged.

### Networking Layer

In the networking layer, a softIRQ 83, which is a handler that is called upon generation of a processing request from the netif_rx 82 and executes the requested processing (software interrupt), and a do_softirq 84, which is a control functional unit that implements the actual software interrupt (softIRQ), are arranged. Further, in the networking layer, a net_rx_action 85, which is a packet processing functional unit executed in response to a software interrupt (softIRQ), a poll_list 86 that registers net device (net_device) information indicating which device the hardware interrupt from the NIC 13 belongs to, and a netif_receive_skb 87 and a ring buffer 72 that create a sk_buff structure (a structure that allows the kernel 71 to recognize the status of packets) are arranged.

### Protocol Layer

In the protocol layer, an ip_rcv 88, an arp_rcv 89, and the like, which are packet processing functional units, are arranged.

The above netif_rx 82, do_softirq 84, net_rx_action 85, netif_receive_skb 87, ip_rcv 88, and arp_rcv 89 are components (names of functions) of a program used for packet processing in the kernel 71.

### Rx-Side Packet Processing Operation Using New API (NAPI)

Arrows (reference signs) d to o in FIG. 12 show the flow of Rx-side packet processing.

When a hardware functional unit 13a (hereinafter referred to as NIC 13) of the NIC 13 receives a packet (or a frame) in a frame from an opposite device, the packet is copied to the ring buffer 72 by direct memory access (DMA) transmission without using a CPU (see reference sign d in FIG. 12). This ring buffer 72 is a memory space in the server and is managed by the kernel 71 (see FIG. 11).

However, only if the NIC 13 simply copies to the ring buffer 72 the packet that has arrived, the kernel 71 cannot recognize the packet. When the packet arrives, the NIC 13 starts up the hardware interrupt (hardIRQ) to the hardIRQ 81 (see reference sign e in FIG. 12), and the netif_rx 82 executes the following processing, so that the kernel 71 recognizes the packet. Note that the hardIRQ 81 surrounded by an ellipse in FIG. 12 represents a handler rather than a functional unit.

The netif_rx 82 is a function that actually performs the processing, and when hardIRQ 81 (handler) is started up (see reference sign f in FIG. 12), it stores, in the poll_list 86, net device (net_device) information indicating which device the hardware interrupt from the NIC 13 belongs to, which is one of the pieces of information in the contents of the hardware interrupt (hardIRQ), and registers a queue harvesting (referring to the contents of the packet stored in the buffer and deleting the corresponding queue entry from the buffer considering the processing of that packet and the next processing) (see reference sign g in FIG. 12). Specifically, upon receiving the packet being stuffed into the ring buffer 72, the netif_rx 82 registers the subsequent queue harvesting in the poll_list 86 using the driver of the NIC 13 (see reference sign g in FIG. 12). Accordingly, in the poll_list 86, queue harvesting information is registered based on packets being stuffed into the ring buffer 72.

In this manner, in “device driver” of FIG. 12, upon receiving a packet, the NIC 13 copies to the ring buffer 72 the packet that has arrived by DMA transfer. The NIC 13 also starts up the hardIRQ 81 (handler), and the netif_rx 82 registers the net_device in the poll_list 86 and schedules a software interrupt (softIRQ).

The processing of the hardware interrupt in “device driver” in FIG. 12 is stopped at this step.

Thereafter, the netif_rx 82 uses information (specifically, a pointer) contained in the queue loaded in the poll_list 86 to start up the harvesting of the data stored in the ring buffer 72 to the softIRQ 83 (handler) by a software interrupt (softIRQ) (see reference sign h in FIG. 12), and notifies the do_softirq 84 which is a control functional unit of the software interrupt (see reference sign i in FIG. 12).

The do_softirq 84 is a software interrupt control functional unit, and defines each software interrupt function (there are various types of packet processing, and interrupt processing is one of them. It defines interrupt processing). Based on this definition, the do_softirq 84 notifies the net_rx_action 85, which actually performs software interrupt processing, of the current (corresponding) software interrupt request (see reference sign j in FIG. 12).

When the softIRQ's turn comes around, the net_rx_action 85 calls a polling routine for harvesting a packet from the ring buffer 72 based on the net_device registered in the poll_list 86 (see reference sign k in FIG. 12), and harvests the packet (see reference sign I in FIG. 12). At this time, the net_rx_action 85 continues harvesting until the poll_list 86 becomes empty.

Thereafter, the net_rx_action 85 notifies the netif_receive_skb 87 (see reference sign m in FIG. 12).

The netif_receive_skb 87 creates a sk_buff structure, analyzes the contents of the packet, and passes processing to the subsequent protocol processing unit 74 (see FIG. 11) for each type. That is, the netif_receive_skb 87 analyzes the contents of the packet, and when performing processing according to the contents of the packet, passes the processing to the ip_rcv 88 of <protocol layer> (see reference sign n in FIG. 12), and if the value is L2, for example, it passes the processing to the arp_rcv 89 (see the reference sign o in FIG. 12).

FIG. 13 is an example of data transmission of video (30 FPS). The workload shown in FIG. 13 has a transmission rate of 350 Mbps, and data is transmitted intermittently every 30 ms.

FIG. 14 is a diagram showing a CPU usage rate used by a polling thread. As shown in FIG. 14, the polling thread monopolizes the CPU core. Even with the intermittent packet reception shown in FIG. 13, the CPU is always used regardless of whether or not a packet has arrived, which causes a problem of increased power consumption.

Next, a DPDK system is described.

### DPDK System Configuration

FIG. 15 is a diagram showing a configuration of a DPDK system that controls HW 10 including an accelerator 12.

The DPDK system includes HW 10, an OS 14, a DPDK 15 that is high-speed data transmission middleware arranged on a user space 60, and a packet processing APL 1.

The packet processing APL 1 is packet processing performed prior to execution of APL.

The HW 10 performs data transmission/reception communication with the packet processing APL 1. In the following description, as shown in FIG. 15, the data flow in which the packet processing APL 1 receives a packet from the HW 10 is referred to as “Rx-side reception,” and the data flow in which the packet processing APL 1 transmits a packet to the HW 10 is referred to as “Tx-side transmission.”

The HW 10 includes an accelerator 12 and a NIC 13 (physical NIC) for connecting to a communication network.

The accelerator 12 is computing unit hardware that performs a specific operation at a high speed based on an input from the CPU. Specifically, the accelerator 12 is a programmable logic device (PLD) such as a graphics processing unit (GPU) or a field programmable gate array (FPGA). In FIG. 15, the accelerator 12 includes a plurality of cores (core processors) 12-1, an Rx queue 12-2 that holds data in a first-in, first-out list structure, and a Tx queue 133.

Part of the processing of the packet processing APL 1 is offloaded to the accelerator 12 to achieve performance and power efficiency that cannot be reached by software (CPU processing) alone.

A case is assumed in which the accelerator 12 as described above is applied in a large-scale server cluster such as a data center that constitutes network functions virtualization (NFV) or software defined network (SDN).

The NIC 13 is NIC hardware that implements a NW interface, and includes an Rx queue 131 and a Tx queue 132 that hold data in a first-in first-out list structure. The NIC 13 is connected to an opposite device 17 via, for example, a communication network and performs packet transmission and reception.

Note that the NIC 13 may be, for example, a Smart NIC that is a NIC with an accelerator. The Smart NIC is a NIC that can reduce the load on the CPU by offloading heavy processing such as IP packet processing that causes a drop in processing performance.

The DPDK 15 is a framework for controlling the NIC in the user space 60, and specifically includes high-speed data transmission middleware. The DPDK 15 includes a poll mode driver (PMD) 16 (a driver that can perform data arrival processing in polling mode or interrupt mode) which is a polling-based reception mechanism. In the PMD 16, a dedicated thread continuously performs data arrival check and reception processing.

The DPDK 15 performs a packet processing function in the user space 60 where APL operates, and performs immediate harvesting when a packet arrives from the user space 60 using a polling model, thereby making it possible to reduce the packet transmission delay. That is, Because the DPDK 15 harvests packets by polling (busy polling the queue on the CPU), there is no waiting and thus the delay is small.

### CITATION LIST

### Non Patent Literature

[NPL 1] Resource settings (NIC)—Introduction to DPDK Part 6, [online], [Retrieved on Jul. 6, 2022], Internet <https://www.ntt-tx.co.jp/column/dpdk_blog/190610/>

### SUMMARY OF INVENTION

### Technical Problem

However, both packet transmission performed using the interrupt model and packet transmission performed using the polling model have the problems described below.

In the interrupt model, the kernel that receives an event (hardware interrupt) from the HW performs packet transmission through software interrupt processing for performing packet processing. For this reason, the interrupt model transmits packets through interrupt (software interrupt) processing, and therefore there is a problem in that a conflict with other interrupts occurs, and a waiting occurs when the interrupt destination CPU is being used for a process with a higher priority, and thus delay in packet transmission increases. In this case, when the interrupt processing is congested, the waiting delay becomes further larger.

In the interrupt model, a mechanism by which delay occurs is additionally explained.

In a typical kernel, packet transmission processing is executed by software interrupt processing after hardware interrupt processing.

When a software interrupt for packet transmission processing occurs, the software interrupt processing cannot be executed immediately under the following conditions (1) to (3). For this reason, as a result of arbitration by a scheduler such as ksoftirqd (a kernel thread for each CPU, which is executed when the software interrupt load is high) and scheduling of interrupt processing, a wait in the ms order occurs.
(1) In a case of conflicting with other hardware interrupt processing
(2) In a case of conflicting with other software interrupt processing
(3) In a case that another process with a high priority is using a kernel thread (migration thread, etc.), or an interrupt destination CPU

Under the above conditions, the software interrupt processing cannot be executed immediately.

Similarly, as for packet processing using a new API (NAPI), as shown by the broken line box p in FIG. 12, NW delay in the ms order occurs due to the conflict between interrupt processing (softIRQ).

### Problem Where Kernel Thread Monopolizes CPU Core

When a kernel thread monopolizes a CPU core to constantly monitor an arrival of a packet, there is a problem in that power consumption increases because CPU time is always used. The relationship between workload and CPU usage rate is described with reference to FIGS. 13 and 14.

Even with an intermittent packet reception as shown in FIG. 13, the CPU is always used regardless of whether or not a packet has arrived, and therefore, as shown in FIG. 14, the CPU usage rate used by the polling thread is 100[%], and the polling thread monopolizes the CPU core. Thus, there is a problem of increased power consumption.

The DPDK also has the same problems as above.

### Problem of DPDK

In the DPDK, the kernel thread monopolizes the CPU core to perform polling (busy polling the queue with the CPU). Therefore, even with intermittent packet reception as shown in FIG. 13, DPDK always uses 100% of the CPU regardless of whether or not a packet has arrived, which poses a problem of increased power consumption.

As described above, Because the DPDK implements a polling model in the user space, softIRQ conflict does not occur, and Because the KBP implements a polling model within the kernel, the softIRQ conflict does not occur, so that packet transmission with low delay is achievable. However, both the DPDK and KBP always waste CPU resources for the packet arrival monitoring regardless of whether or not a packet has arrived, which poses a problem of increased power consumption.

To bypass a kernel protocol stack, it is possible to define the necessary network protocol processing in a user space as appropriate for the application. For example, there are definitions such as that the connection between a radio unit (RU) and a distributed unit (DU) in a radio access network (RAN) between base stations (base band unit: BBU) is often established via Ethernet (L2), that an L3/L4 protocol is not necessary for the vDU application and may be omitted, and the like.

However, Because there is a polling thread in the user space, CPU frequency control that is coordinated with sleep control of the polling thread is executed from the user space on the CPU. For this reason, a state transition occurs between the user space and the kernel mode, and it takes time for the frequency settings to be reflected, and when the frequency reflection control in an order of several microseconds to several tens of microseconds is required, such as in RAN Front Haul, there is a problem that it cannot be done in time.

The present invention has been made in view of the above background, and an object of the present invention is to avoid context switch overhead, enable high-speed reflection of settings, and transmission data that arrives at an interface unit to an application in a power-saving and low delay manner.

### Solution to Problem

In order to solve the above problems, the present invention discloses an on-server data transmission controller that transmits data that has arrived at an interface unit to an application in a user space via an OS, the OS including a kernel, and a driver capable of processing arrival of data from the interface unit in a polling mode or an interrupt mode, the on-server data transmission controller including: a packet arrival monitoring unit configured to start up a thread that monitors an arrival of a packet using a polling model in the kernel; and a transmission processing unit configured to, when the packet arrival monitoring unit detects the arrival of the packet, notify a protocol processing unit of the application of presence of the arriving packet without using a kernel protocol stack.

### Advantageous Effects of Invention

According to the present invention, it is possible to avoid the context switch overhead, enable high-speed reflection of settings, and transmission data that has arrived at an interface unit to an application in a power-saving and low delay manner.

### BRIEF DESCRIPTION OF DRAWINGS

FIG. 1 is a schematic configuration diagram of a data transmission system according to an embodiment of the present invention.

FIG. 2 is an explanatory diagram of an operation of the data transmission system according to the embodiment of the present invention, which uses a method of distributing a shared memory area between an application and a NIC driver in advance.

FIG. 3 is a flowchart showing an operation of a NIC and HW interrupt processing in the data transmission system according to the embodiment of the present invention, which uses the method of distributing the shared memory area between the application and the NIC driver in advance.

FIG. 4 is a flowchart showing an operation of a polling thread in the data transmission system according to the embodiment of the present invention, which uses the method of distributing the shared memory area between the application and the NIC driver in advance.

FIG. 5 is an explanatory diagram of an operation of the data transmission system using a method of providing a notification of pointer information of packets in the data transmission system according to the embodiment of the present invention.

FIG. 6 is a flowchart showing an operation of a polling thread using a method of providing a notification of pointer information of packets in the data transmission system according to the embodiment of the present invention.

FIG. 7 is a hardware configuration diagram showing an example of a computer that implements functions of an on-server data transmission controller of the data transmission system according to the embodiment of the present invention.

FIG. 8 is a diagram showing an interrupt model of a data transmission system according to an embodiment of the present invention in a server virtualization environment structured with a general-purpose Linux kernel (registered trademark) and a VM configuration.

FIG. 9 is a diagram showing an operation of a data arrival monitoring unit of a data transmission unit of a data transmission system according to an embodiment of the present invention.

FIG. 10 is a diagram illustrating a packet transmission using a polling model in a configuration of OvS-DPDK.

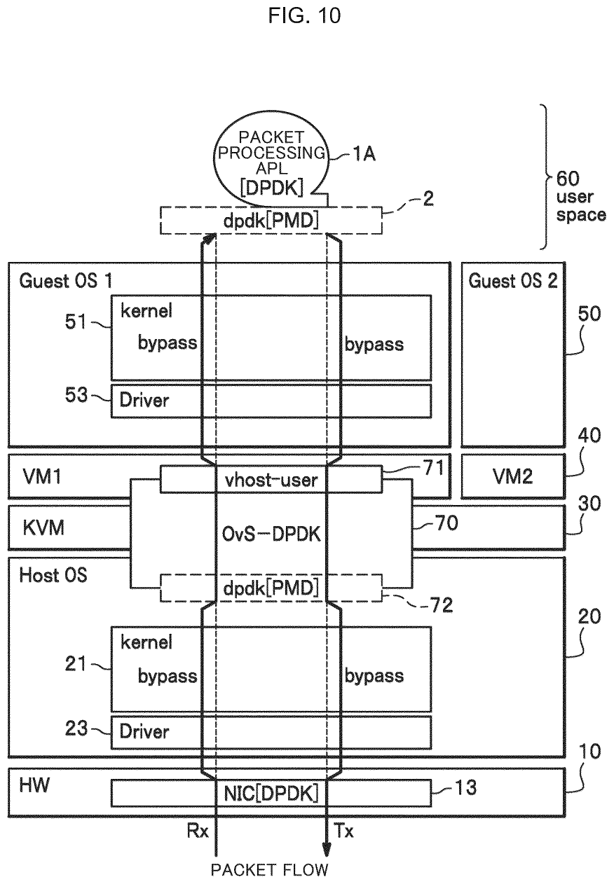

FIG. 11 is a schematic diagram of Rx-side packet processing using a new API (NAPI) implemented by Linux kernel 2.5/2.6 or below.

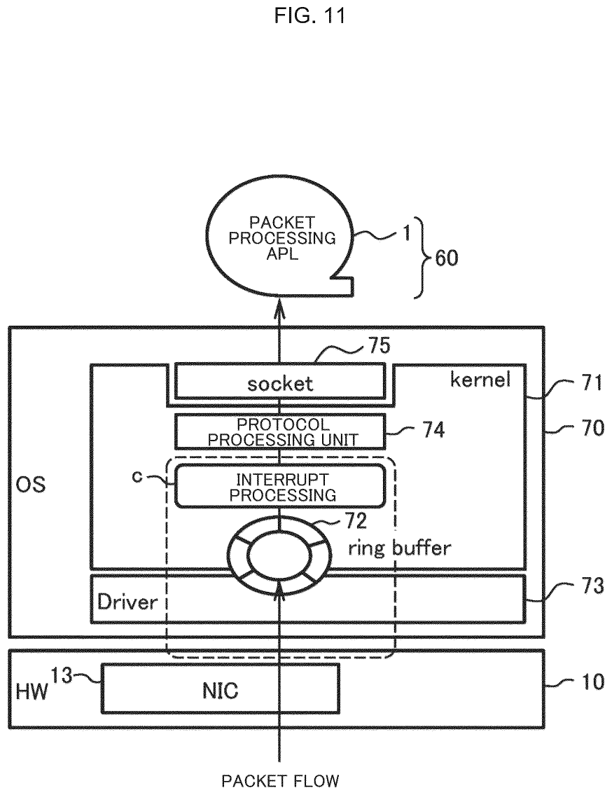

FIG. 12 is a diagram illustrating an outline of Rx-side packet processing using a new API (NAPI) at a position surrounded by a broken line in FIG. 11.

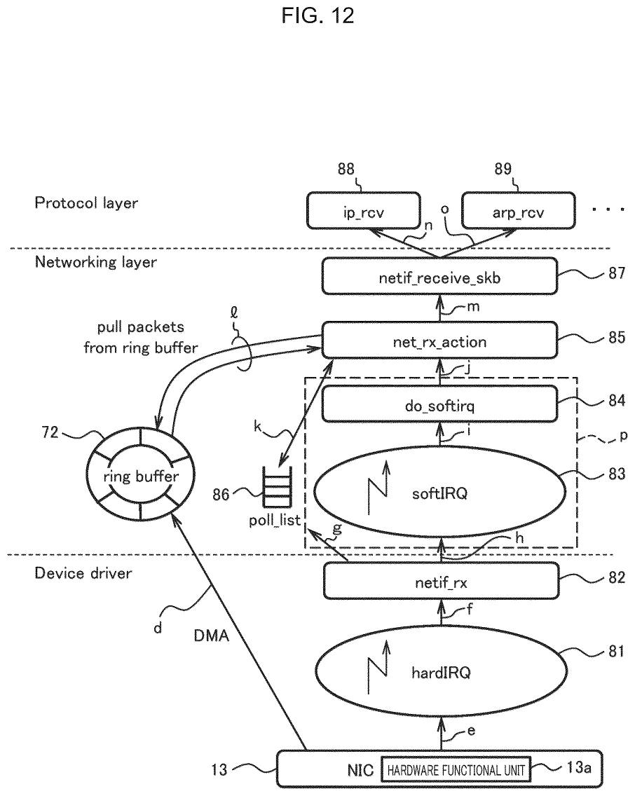

FIG. 13 is a diagram showing an example of data transmission of video (30 FPS).

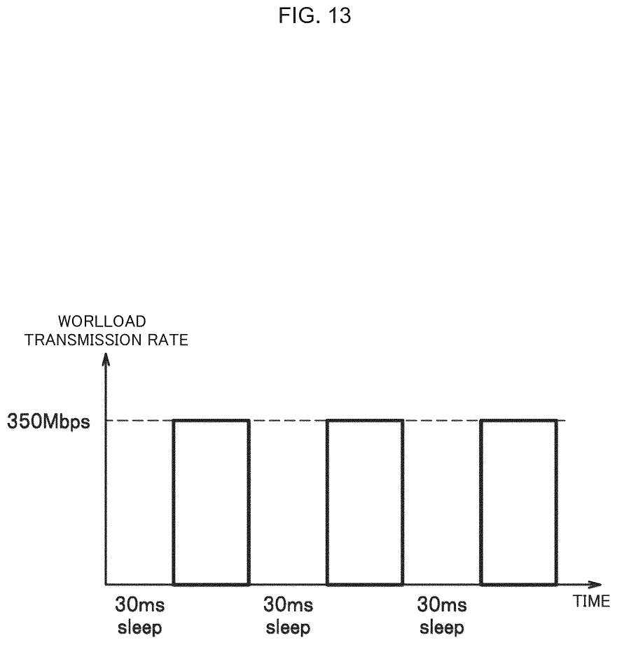

FIG. 14 is a diagram showing a CPU usage rate used by a polling thread.

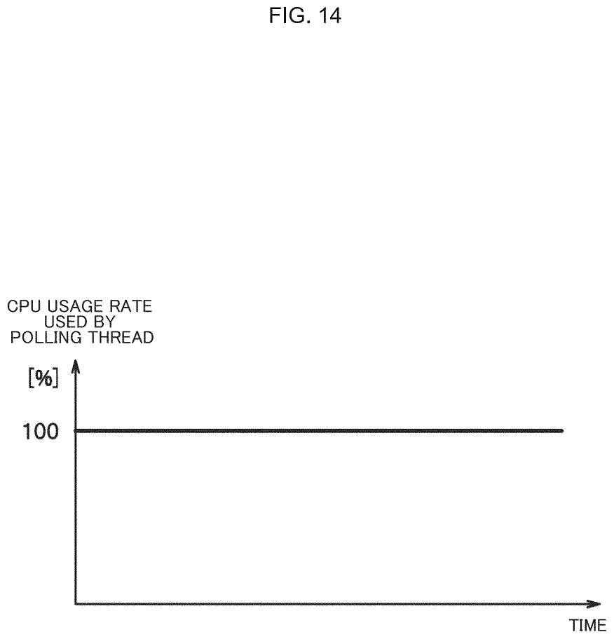

FIG. 15 is a diagram showing a configuration of a DPDK system that controls HW equipped with an accelerator.

### DESCRIPTION OF EMBODIMENTS

A data transmission system and the like in a mode for carrying out the present invention (the mode is hereinafter referred to as “the present embodiment”) is described below with reference to the drawings.

### Principle Description

### Features of Present Invention

First, features of the present invention is described.

When there is a polling thread in a user space, a state transition between the user space and a kernel mode occurs, and this poses a problem that it takes time for the frequency settings to be reflected. The present invention aims to shorten the time required to reflect the frequency settings, thereby effectively achieving low delay and low power consumption.

### Feature 1

A polling thread is provided in the kernel, and a CPU operating frequency and a CPU idle state are controlled in the kernel mode. As a result, the context switch overhead can be avoided and settings can be reflected at a high speed.

### Feature 2

A polling thread is provided in the kernel, and a mechanism is provided to transmit pointer information of packets that arrive to the user space application. As a result, a kernel protocol stack is bypassed and user space applications can select and use any protocol.

### Features of Polling Thread

Next, the features of the polling thread is described.

The polling thread (on-server data transmission controller 100) has the following features.

### <Feature 3>: Low Delay

The polling thread stops softIRQ for packet processing, which is a main cause of NW delay, and a packet arrival monitoring unit 110 (described below) of the on-server data transmission controller 100 executes the polling thread for monitoring packet arrival. Then, when a packet arrives, the packet is processed using the polling model (without softIRQ).

When a packet arrives, by activating the polling thread with the hard interrupt handler, softIRQ conflict can be avoided and packet transmission processing can be performed immediately. In other words, by keeping the packet arrival monitoring function on standby and activating it with a hard interrupt, it is possible to achieve lower delay than packet transmission processing using a software interrupt such as NAPI.

Additionally, when a packet arrives during sleep, the polling thread is started using a high-priority hardIRQ, and therefore the overhead caused by sleep can be suppressed as much as possible.

### <Feature 4>: Power Saving (Part 1)

The polling thread (on-server data transmission controller 100) monitors the arrival of packets and can sleep while no packets arrive.

While no packets have arrived, the polling thread sleeps and controls the CPU frequency to be set low. Therefore, an increase in power consumption due to busy polling can be suppressed.

### <Feature 5>: Power Saving (Part 2)

A CPU frequency/CPU idle state control unit 140 (described below) of the on-server data transmission controller 100 changes the CPU operating frequency and idle setting depending on whether or not a packet has arrived. Specifically, the CPU frequency/CPU idle state control unit 140 lowers the CPU frequency during sleep, and increases the CPU frequency when activated again (returns the CPU operating frequency to the original). Further, the CPU frequency/CPU idle state control unit 140 changes the CPU idle setting to power saving during sleep. Power saving is also achieved by changing the CPU operating frequency to a lower value during sleep and by changing the CPU idle setting to power saving mode.

In this way, the polling thread is provided in the kernel to control the CPU frequency and CPU idle state in the kernel mode. Because settings are reflected quickly without a context switch, settings can be reflected at a high speed in the order of several microseconds.

### EMBODIMENTS

### Overall Configuration

A data transmission system and the like in a mode for carrying out the present invention (the mode is hereinafter referred to as “the present embodiment”) is described below with reference to the drawings.

### Overview

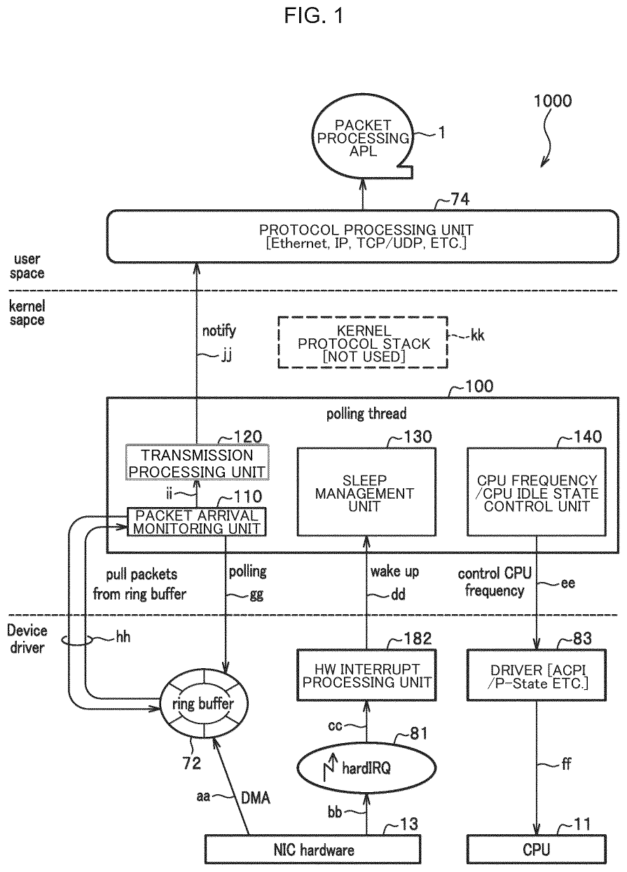

FIG. 1 is a schematic configuration diagram of a data transmission system according to an embodiment of the present invention. The present embodiment is an example in which a new API (NAPI) implemented in Linux kernel 2.5/2.6 or later is applied to Rx-side packet processing.

As shown in FIG. 1, a data transmission system 1000 executes a packet processing APL 1 placed in a user space usable by a user on a server including an OS (for example, a host OS), and performs packet transmission between a NIC 13 of HW connected to the OS and the packet processing APL 1.

The data transmission system 1000 includes a network interface card (NIC) 13 (interface unit), a hardIRQ 81, which is a handler that is called upon generation of a processing request from the NIC 13 and executes the requested processing (hardware interrupt), a HW interrupt processing unit 182, which is a processing functional unit of a HW interrupt, a ring buffer 72, a polling thread (on-server data transmission controller 100), and a protocol processing unit 74.

The ring buffer 72 is managed by the kernel in a memory space within the server. The ring buffer 72 is a buffer of a fixed size that stores a location of a packet when the packet arrives, and is overwritten from the beginning when the upper limit size is exceeded.

The protocol processing unit 74 uses Ethernet, IP, TCP/UDP, etc. placed in the user space. The protocol processing unit 74 performs, for example, L2/L3/L4 protocol processing defined by the OSI reference model.

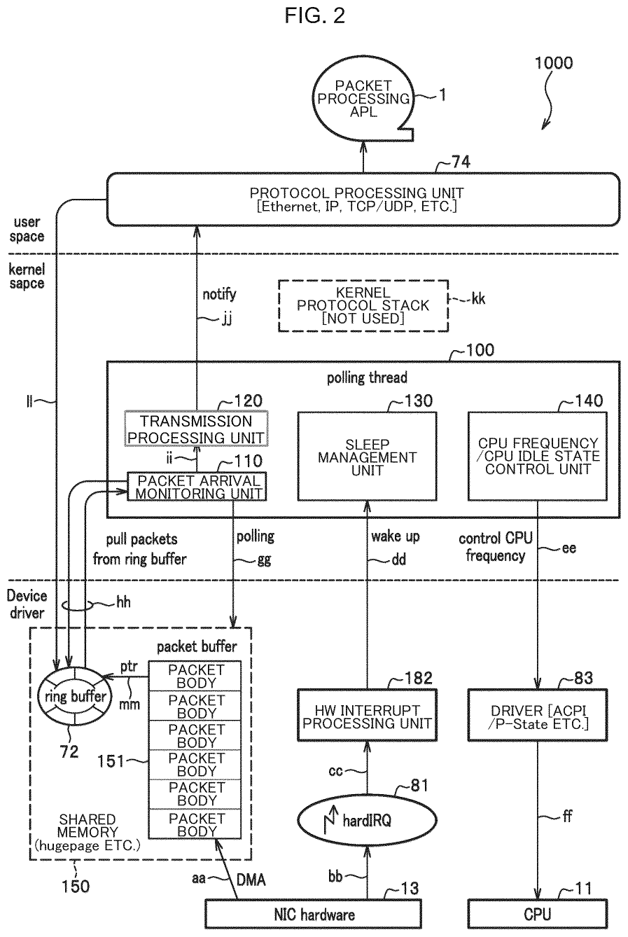

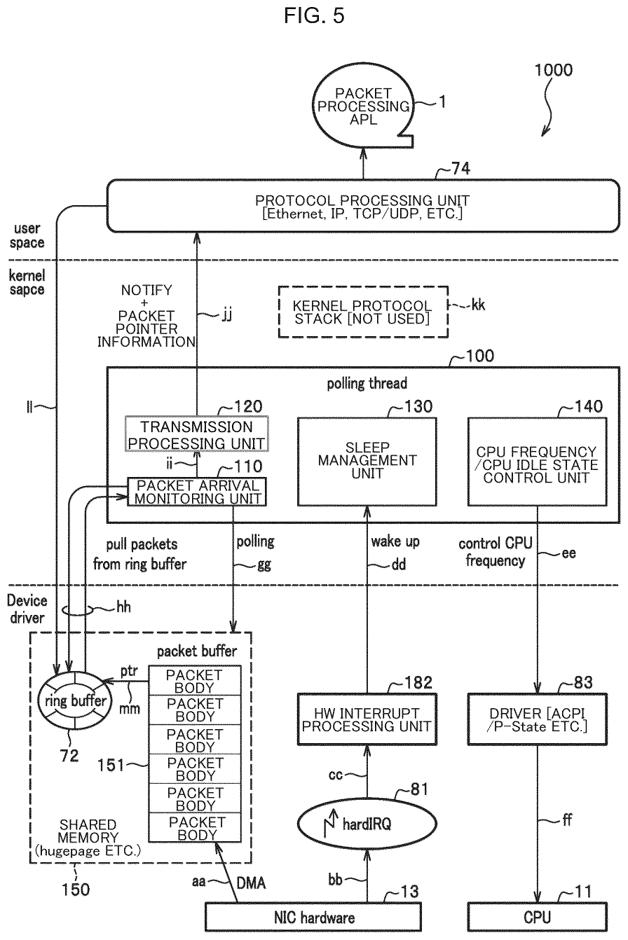

Methods of distributing pointer information to applications include (1) a method of distributing a shared memory area between an application and a NIC driver in advance, and (2) a method of providing a notification of pointer information of packets.
(1) In the case of the method of distributing the shared memory area between the application and the NIC driver in advance (FIG. 2), the protocol processing unit 74 acquires memory address information of the buffer through distribution with the driver, and recognizes the location of the ring buffer 72 on a shared memory 150 (FIGS. 2 and 5) in advance.

Because the protocol processing unit 74 of the APL 1 is notified only of an arrival of a packet from the polling thread (on-server data transmission controller 100), the protocol processing unit 74 can check the storage destination of the data (payload) of the packet body by referring to the ring buffer 72 (see the arrow with the reference sign II in FIG. 2) on the shared memory 150 (FIGS. 2 and 5) and obtaining pointer information. In this way, by obtaining pointer information, it is possible to find the location of the packet body.
(2) In the case of the method of providing a notification of pointer information of packets (FIG. 5), upon receiving the notification, the protocol processing unit 74 acquires the arriving packet on the basis of the pointer information sent along with the notification from the transmission processing unit 120. That is, the protocol processing unit 74 uses the polling thread pointer information to extract the payload from the shared memory 150 (FIGS. 2 and 5).

### On-Server Data Transmission Controller 100

### Arrangement of On-Server Data Transmission Controller 100

Kernel space arrangement of polling thread

In the data transmission system 1000, a polling thread (on-server data transmission controller 100) is arranged in the kernel space. This polling thread (on-server data transmission controller 100) operates within the kernel space. The data transmission system 1000 executes the packet processing APL 1 placed in a user space on a server including an OS, and performs packet transmission between the NIC 13 of HW and the packet processing APL 1 via a device driver connected to the OS.

In the device driver, the hardIRQ 81, the HW interrupt processing unit 182, and the ring buffer 72 are arranged.

The device driver is a driver for monitoring hardware.

The present invention can be used when it is desired to transmit and receive packets in a low delay and power-saving manner by independently defining a protocol to be used in a user space, and also performing polling mode and sleep.

As described above, the on-server data transmission controller 100 is a polling thread placed in the kernel space. Low delay is achieved by arranging the on-server data transmission controller 100 (polling thread) in the kernel and performing packet arrival monitoring and reception processing with the polling model.

### Configuration of On-Server Data Transmission Controller 100

The on-server data transmission controller 100 includes a packet arrival monitoring unit 110, a transmission processing unit 120, a sleep management unit 130, and a CPU frequency/CPU idle state control unit 140.

### Packet Arrival Monitoring Unit 110

The packet arrival monitoring unit 110 is a thread for monitoring whether or not a packet has arrived.

The packet arrival monitoring unit 110 starts up a thread that monitors arrival of a packet using a polling model in the kernel.

The packet arrival monitoring unit 110 acquires pointer information indicating that the packet exists in the ring buffer 72 and net_device information, and transmits the information (pointer information and net_device information) to the transmission processing unit 120.

### Transmission Processing Unit 120

When the packet arrival monitoring unit 110 detects the arrival of a packet, the transmission processing unit 120 notifies the protocol processing unit 74 of the application of the arriving packet without using the kernel protocol stack.

Methods of distributing pointer information to applications include (1) a method of distributing a shared memory area between an application and a NIC driver in advance, and (2) a method of providing a notification of pointer information of packets.
(1) In the case of a method of distributing a shared memory area between the application and the NIC driver in advance (FIG. 2), the transmission processing unit 120 notifies the APL 1 only that the packet has arrived without using the kernel protocol stack on the basis of the packet arrival from the packet arrival monitoring unit 110. That is, the transmission processing unit 120 extracts the packet from the ring buffer 72 on the basis of the received information and does not transmit the packet to the protocol processing unit 74, but only notifies the protocol processing unit 74 that the packet has arrived.
(2) In the case of the method of providing a notification of pointer information of packets (FIG. 5), the transmission processing unit 120 notifies the protocol processing unit 74 and also sends pointer information indicating the storage destination of the arriving packet (notify +pointer information).

### Sleep Management Unit 130

The sleep management unit 130 causes a thread (polling thread) to sleep when a packet does not arrive for a predetermined period of time, and cancels sleep using a hardware interrupt (hardIRQ) of this thread (polling thread) when a packet arrives.

### CPU Frequency/CPU Idle Control Unit 140

The CPU frequency/CPU idle state control unit 140 sets the CPU operating frequency of the CPU core used by the thread (polling thread) to be low during sleep. The CPU frequency/CPU idle state control unit 140 sets the CPU idle state of the CPU core used by this thread (polling thread) to a power saving mode during sleep.

The operation of the data transmission system 1000 is described below.

### Operation of RX-Side Packet Processing According to Present Invention

Arrows (reference signs) aa to jj in FIG. 1 show the flow of Rx-side packet processing.

When the NIC 13 receives a packet (or a frame) in a frame from an opposite device, the packet arriving at the ring buffer 72 is copied by DMA transfer without using a CPU (see reference sign aa in FIG. 1). This ring buffer 72 is managed by “device driver”.

When the packet arrives, the NIC 13 starts up the hardware interrupt (hardIRQ) to the hardIRQ 81 (handler) (see reference sign bb in FIG. 1), and the HW interrupt processing unit 182 executes the following processing to recognize the packet.

When the hardwire 81 (handler) is started up (see reference sign cc in FIG. 1), the HW interrupt processing unit 182 cancels sleep by waking up the sleeping polling thread (see reference sign dd in FIG. 1).

The processing of the hardware interrupt in “device driver” in FIG. 1 is stopped here.

On the other hand, the CPU frequency/CPU idle state control unit 140 sets the CPU operating frequency of the CPU core used by the thread (polling thread) to be low during sleep. The CPU frequency/CPU idle state control unit 140 sends a frequency control signal (control CPU frequency) for setting the CPU operating frequency to be low to a CPU 11 (see reference sign ff in FIG. 1) via a driver 83 such as ACPI/P-State (see reference sign ee in FIG. 1).

The packet arrival monitoring unit 110 monitors (polls) the ring buffer 72 (see reference sign gg in FIG. 1) and checks whether or not a packet has arrived. Because the packet arrival monitoring unit 110 stores packets in the ring buffer 72 in a pre-secured area, it can be determined whether a new packet has arrived by referring to the ring buffer 72 in the pre-secured area.

When a packet has arrived, the packet arrival monitoring unit 110 harvests the packet from the ring buffer 72 (see reference sign hh in FIG. 1). At this time, if packet pointer information is transmitted by a HW interrupt, it may be used (pull packets from the ring buffer).

The packet arrival monitoring unit 110 extracts a packet from the ring buffer 72 on the basis of the received information and sends it to the transmission processing unit 120 (see reference sign ii in FIG. 1).

The transmission processing unit 120 transmits the packet received by the packet arrival monitoring unit 110 to the protocol processing unit 74 (see reference sign jj in FIG. 1).

At this time, the packet arrival monitoring unit 110 and the transmission processing unit 120 do not use the kernel protocol stack (see broken line box kk in FIG. 1), but notify the user space of the pointer information of the packet received from the NIC 13 (notifies using signalfd, a proprietary API, etc.). In other words, the packet arrival monitoring unit 110 and the transmission processing unit 120 bypass the kernel protocol stack and notify the user space of the pointer information of the packet received by the polling thread from the NIC.

Note that the ring buffer 72 is stored and managed by DMA from the NIC 13 in a format that is easy for the APL 1 to use (for example, mbuf in the case of DPDK).

A more detailed description is given.

The data transmission system 1000 installs the on-server data transmission controller 100 (polling thread) in the kernel, does not use the kernel protocol stack, but notifies the user space of the pointer information of the packet received from the NIC 13 (notifies using eventfd, signalfd, a proprietary API, etc.). That is, the on-server data transmission controller 100 bypasses the kernel protocol stack and notifies the user space of the pointer information of the packet received by the polling thread from the NIC 13. The protocol processing unit 74 receives only notifications of pointer information of packets received from the polling thread.

The protocol processing unit 74 of the APL 1 in the user space recognizes the location of the ring buffer on the shared memory 150 in advance. When the pointer information of the packet received from the NIC 13 is notified, in order to obtain the data (payload) of the packet body, the protocol processing unit 74 can check the storage destination of the data (payload) of the packet body by referring to the ring buffer 72 on the shared memory 150 and obtaining the pointer information on the basis of the notified pointer information. Thereby, like DPDK, user space applications can select and use the required protocols.

### Buffer Structure and Methods of Distributing Pointer Information to Applications

The buffer structure of the on-server data transmission controller 100 and the methods of distributing pointer information to applications is described.

Methods of distributing pointer information to applications include (1) a method of distributing a shared memory area between an application and a NIC driver in advance, and (2) a method of providing a notification of pointer information of packets. Hereinafter, description is given in order.

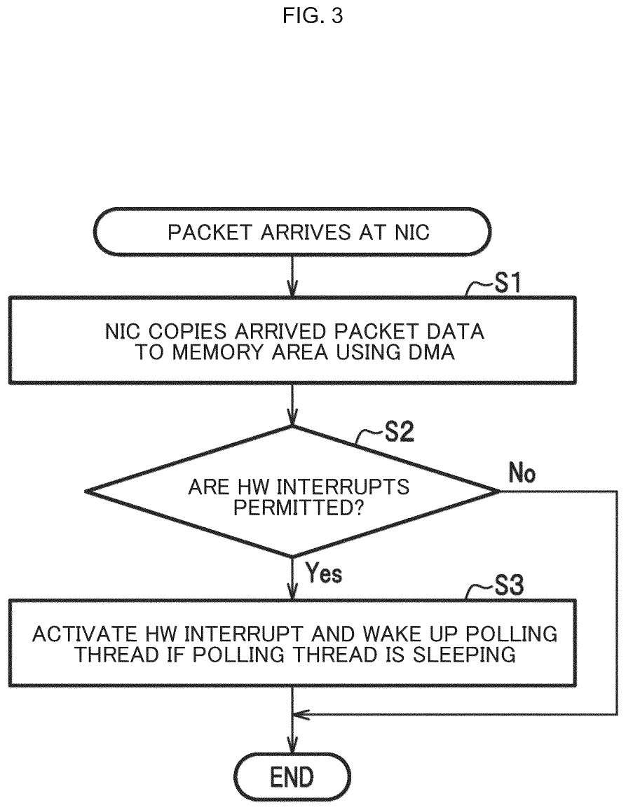

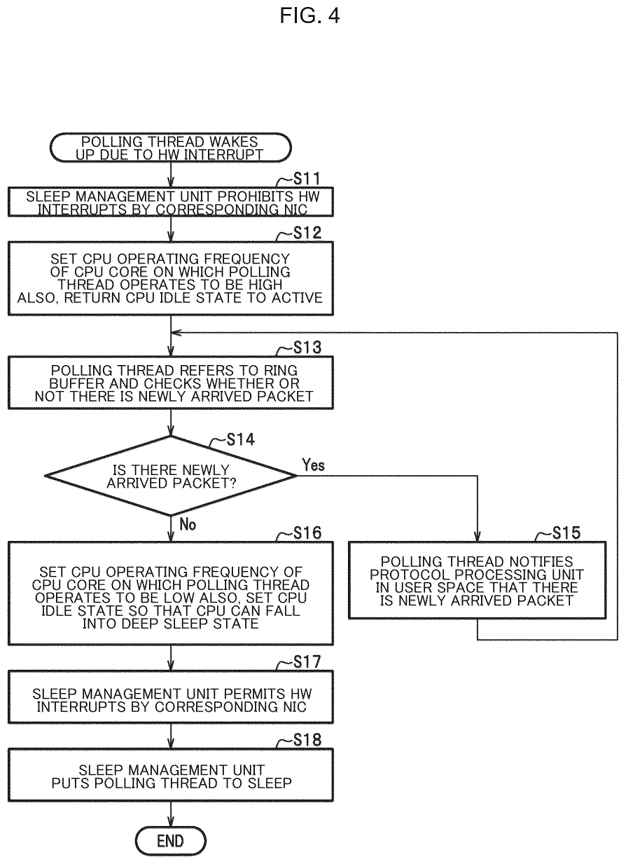

First, (1) the method of distributing a shared memory area between the application and the NIC driver in advance is described with reference to the explanatory diagram of the operation of FIG. 2 and the flowcharts of FIGS. 3 and 4.

FIG. 2 is an explanatory diagram of the operation of the data transmission system using the method of distributing the shared memory area between the application and the NIC driver in advance. The same components as those in FIG. 1 are denoted by the same reference signs.

As shown in FIG. 2, the shared memory 150 on the device driver is composed mainly of hugepage, etc., and has a packet buffer 151 and a ring buffer 72.

The device driver manages pointer information of the packet buffer 151. The protocol processing unit 74 of the APL 1 recognizes memory address information of the ring buffer 72 on the shared memory 150 in advance, and can check the storage destination of the data (payload) of the packet body by referring to the ring buffer 72 (see reference sign Il in FIG. 2: packet) and obtaining pointer information.

By securing a shared memory area such as hugepage in advance between the APL 1 and the NIC driver, and the APL 1 knowing the memory address information of the ring buffer 72 in advance, even if pointer information of the packet is not notified from the polling thread, referring to the ring buffer 72 makes it possible to check the storage destination of the data (payload) of the packet body.

FIG. 3 is a flowchart showing an operation of NIC and HW interrupt processing using the method of distributing the shared memory area between the application and the NIC driver in advance. The operation of this flow is written in the NIC driver.

This flow starts when a packet arrives at the NIC.

In step S1, the NIC 13 copies the arrived packet data to the memory area using DMA. At this time, the stored data format (structure) is stored in a format that is easy for the APL 1 that receives the packet to use. For example, in the case of a DPDK application, it is mbuf, etc. The NIC driver stores pointer information of the memory area in which the packet is stored in the ring buffer 72. The packet arrival monitoring unit 110 of the polling thread monitors the arrival of this ring buffer 72.

In step S2, the HW interrupt processing unit 182 located in the NIC driver determines whether or not HW interrupts are permitted. When HW interrupts are not permitted (S2: No), the processing of this flow ends.

When HW interrupts are permitted (S2: Yes), in step S3, the HW interrupt processing unit 182 activates a HW interrupt (hardIRQ 81), and if the polling thread is sleeping, wakes up the polling thread and ends the processing of this flow. Because it is woken up by a HW interrupt, the delay is low. At this time, the pointer information of the arrived packet may be transmitted to the polling thread.

FIG. 4 is a flowchart showing an operation of the polling thread using the method of distributing the shared memory area between the application and the NIC driver in advance.

The polling thread is woken up by a HW interrupt, and this flow starts.

In step S11, the sleep management unit 130 prohibits a HW interrupt activated by the corresponding NIC.

In step S12, the CPU frequency/CPU idle state control unit 140 sets the CPU operating frequency of the CPU core on which the polling thread operates to be high. Further, the CPU frequency/CPU idle state control unit 140 returns the CPU idle state to ACTIVE. Because this processing is executed in the kernel mode, there is no context switch overhead for switching between the user mode and the kernel mode, and it can be reflected at a high speed.

In step 13, the packet arrival monitoring unit 110 of the polling thread refers to the ring buffer 72 and checks whether or not there is a newly arrived packet. At this time, if packet pointer information is transmitted by a HW interrupt, it may be used.

In step S14, the packet arrival monitoring unit 110 determines whether or not there is a newly arrived packet.

When there is a newly arrived packet (S14: Yes), the polling thread notifies the protocol processing unit 74 of the APL 1 in the user space that there is a newly arrived packet in step S15, and returns to step S13. In this notification, a context switch from the kernel mode to the user mode occurs.

Here, the method of notifying and transmitting the newly arrived packet to the application in the user space uses mechanisms such as eventfd and signalfd provided in the kernel. Alternatively, a unique application programming interface (API) may be defined.

Furthermore, when there are a plurality of newly arrived packets, the plurality of packets may be notified and transmitted as a list (batch processing).

As described in FIG. 2, even if the pointer information where the packet is stored is not transmitted to the application, the application knows the address of the ring buffer 72 in the shared memory area secured in advance, and can ascertain the location of the packet by referring to the corresponding ring buffer 72.

When there is no newly arrived packet (S14: No), the CPU frequency/CPU idle state control unit 140 of the polling thread sets the CPU operating frequency of the operating CPU core to be low in step S16. Further, the CPU frequency/CPU idle control state unit 140 sets the CPU idle state so that the CPU can fall into a deep sleep state. Because this processing is executed in the kernel mode, there is no context switch overhead for switching between the user mode and the kernel mode, and it can be reflected at a high speed.

In step S17, the sleep management unit 130 permits a HW interrupt to be activated by the corresponding NIC.

In step S18, the sleep management unit 130 puts the polling thread to sleep and ends the processing of this flow.

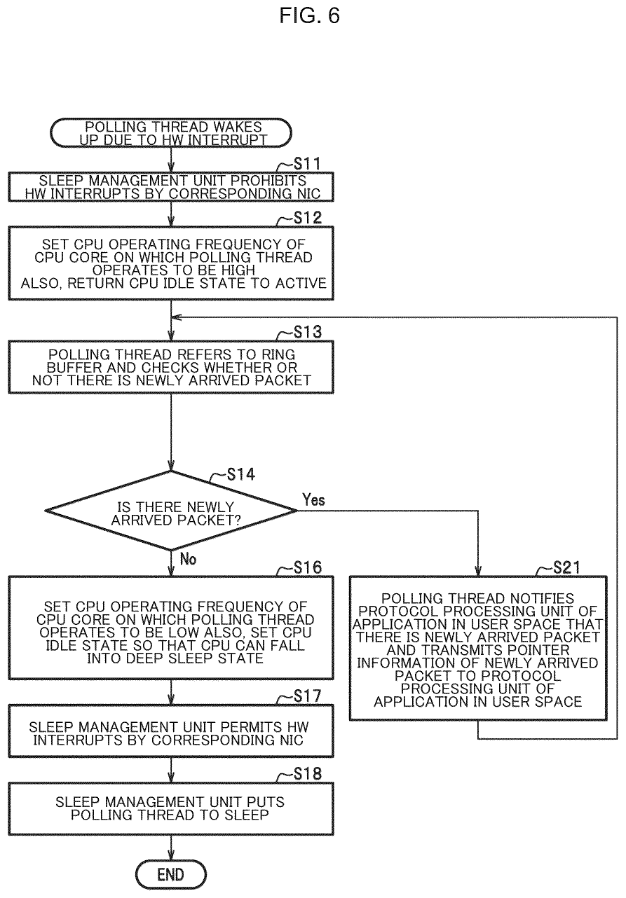

Next, (2) the method of providing a notification of pointer information of packets is described with reference to the explanatory diagram of the operation of FIG. 5 and the flowchart of FIG. 6.

FIG. 5 is an explanatory diagram of the operation of the data transmission system using the method of providing a notification of pointer information of packets. The same components as those in FIG. 1 are denoted by the same reference signs.

As shown in FIG. 5, the shared memory 150 on the device driver is composed mainly of hugepage, etc., and has a packet buffer 151 and a ring buffer 72.

The device driver manages pointer information of the packet buffer 151.

When the polling thread notifies the APL 1 of the arrival of a packet, it notifies the APL 1 of pointer information of the packet (which may include memory address information of the ring buffer 72). Thereby, the APL 1 can check the storage destination of the data (payload) of the packet body without knowing in advance the memory address information of the ring buffer 72 or the packet buffer 15172.

The polling thread notifies the APL 1 of the pointer information of the packet, and thereby the APL 1 ascertains the storage destination of the data (payload) of the packet body. With this method, there is no need to distribute in advance the memory address information of the ring buffer 72 between the application and the NIC driver. Thus, the method has flexibility such as dynamically changing the locations of the ring buffer 72 and the packet buffer 151.

Because the flowchart showing the operation of the NIC and HW interrupt processing using the method of providing a notification of pointer information of packets is the same as that in FIG. 3, the description thereof is omitted.

FIG. 6 is a flowchart showing the operation of the polling thread using the method of providing a notification of pointer information of packets. Steps that perform the same processing as those in FIG. 4 are given the same reference signs and descriptions are omitted.

When there is a newly arrived packet in step S14 (S14: Yes), in step S21, the polling thread notifies the protocol processing unit 74 of the APL 1 in the user space that there is a newly arrived packet and transmits the pointer information of the newly arrived packet to the protocol processing unit 74 of the APL 1 in the user space, and returns to step S13. In this notification, a context switch from the kernel mode to the user mode occurs. When there are a plurality of newly arrived packets, the plurality of packets may be transmitted as a list (batch processing).

### Hardware Configuration

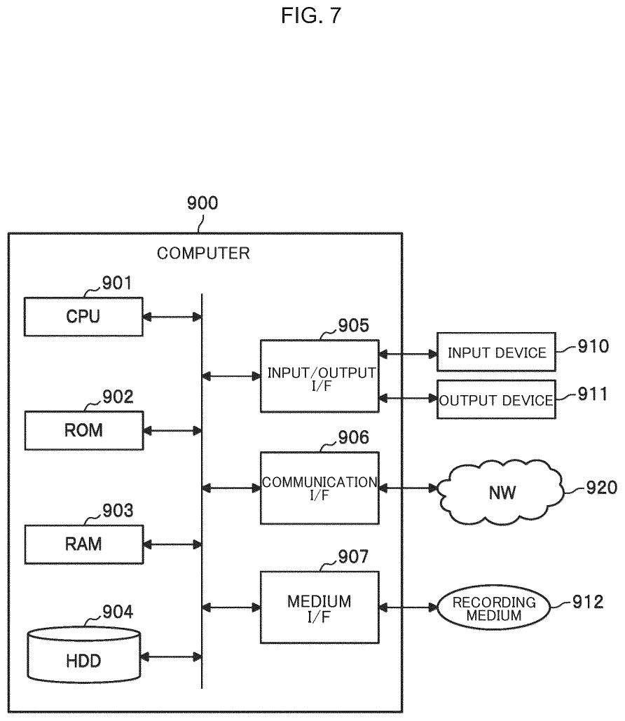

The on-server data transmission controller 100 (FIGS. 1, 2, and 5) according to the embodiments described above is implemented, for example, by a computer 900 having a configuration as shown in FIG. 7.

FIG. 7 is a hardware configuration diagram showing an example of the computer 900 that implements the functions of the on-server data transmission controller 100 (FIGS. 1, 2, and 5).

The computer 900 includes a CPU 901, a ROM 902, a RAM 903, an HDD 904, an input/output interface (I/F) 905, a communication interface (I/F) 906, and a medium interface (I/F) 907.

The CPU 901 operates on the basis of a program stored in the ROM 902 or the HDD 904, and controls each unit of the on-server data transmission controller 100 (FIGS. 1, 2, and 5). The ROM 902 stores a boot program executed by the CPU 901 when the computer 900 is activated, a program depending on the hardware of the computer 900, and the like.

The CPU 901 controls, via the input/output I/F 905, an input device 910 such as a mouse or a keyboard, and an output device 911 such as a display. The CPU 901 acquires data from the input device 910 and outputs the generated data to the output device 911 via the input/output I/F 905. Note that a graphics processing unit (GPU) or the like may be used as a processor in conjunction with the CPU 901.

The HDD 904 stores programs executed by the CPU 901, data used by the programs, and the like. The communication I/F 906 receives data from another device via a communication network (for example, a network (NW) 920), outputs the data to the CPU 901, and transmits data generated by the CPU 901 to another device via the communication network.

The medium I/F 907 reads a program or data stored in a recording medium 912 and outputs the read program or data to the CPU 901 via the RAM 903. The CPU 901 loads a program related to target processing from the recording medium 912 onto the RAM 903 via the medium I/F 907, and executes the loaded program.

The recording medium 912 may be an optical recording medium such as a digital versatile disc (DVD) or a phase change rewritable disk (PD), a magneto-optical recording medium such as a magneto-optical disk (MO), a magnetic recording medium, a conductor memory tape medium, a semiconductor memory, or the like.

For example, when the computer 900 functions as the on-server data transmission controller 100 (FIGS. 1, 2, and 5) configured as one device according to the present embodiment, the CPU 901 of the computer 900 implements the functions of the on-server data transmission controller 100 by executing the program loaded onto the RAM 903. In addition, the HDD 904 stores data in the RAM 903. The CPU 901 reads a program related to target processing from the recording medium 912, and executes the program. Additionally, the CPU 901 may read a program related to the target processing from another device via the communication network (NW 920).

### Application Example

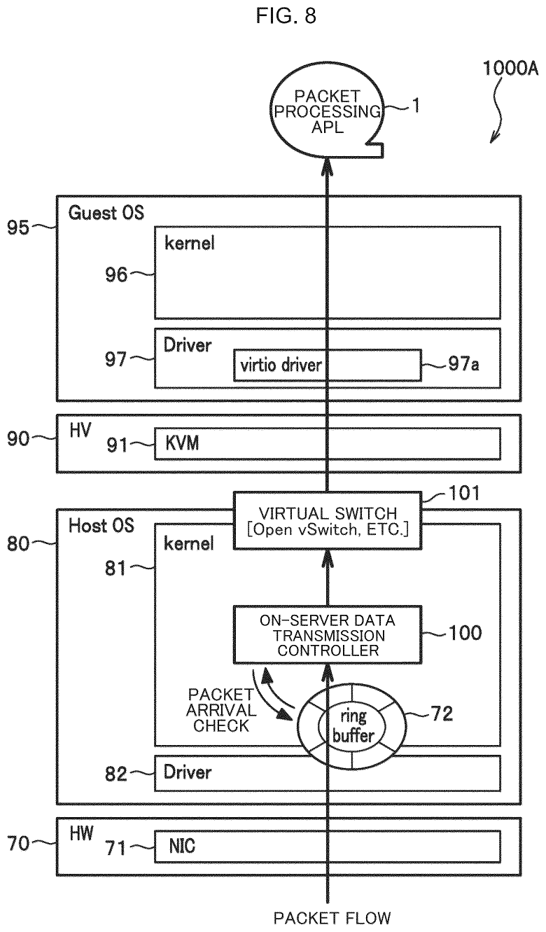

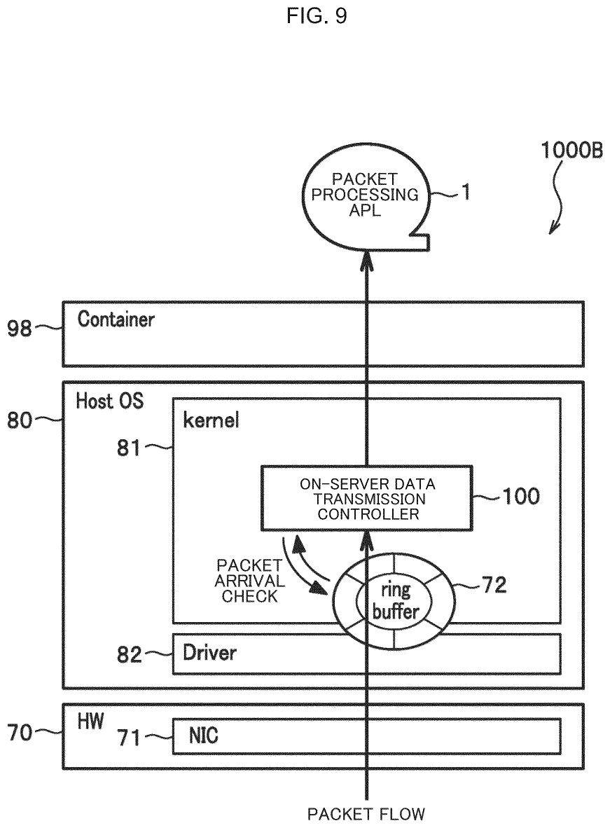

The on-server data transmission controller 100 is applicable to configuration examples in which the device 100 is placed in the OS 50. In this case, the OS type is not limited. Also, there is no limitation for the device 100 to being under a server virtualization environment. Therefore, the on-server data transmission controller 100 (FIGS. 1, 2, and 5) can be applied to each of the configurations shown in FIGS. 8 and 9.

### Example of Application to VM Configuration

FIG. 8 is a diagram showing an example in which a data transmission system 1000A is applied to an interrupt model in a server virtualization environment with a general-purpose Linux kernel (registered trademark) and a VM configuration. The same components as those in FIG. 1 are denoted by the same reference signs.

As shown in FIG. 8, the data transmission system 1000A includes a host OS 80 in which a virtual machine and an external process formed outside the virtual machine can operate, and the host OS 80 includes a kernel 81 and a driver 82. The data transmission system 1000A also includes a NIC 71 of HW 70 connected to the host OS 80 and a KVM module 91 incorporated in a hypervisor (HV) 90. Furthermore, the data transmission system 1000A includes a guest OS 95 that operates within a virtual machine, and the guest OS 95 includes a kernel 96 and a driver 97.

The data transmission system 1000A includes a polling thread (on-server data transmission controller 100) in the kernel space.

As described above, in a system with a virtual server configuration of VMs, data that has arrived at the interface unit can be transmitted to an application in a power-saving and low delay manner in both the host OS 80 and the guest OS 95.

### Example of Application to Container Configuration

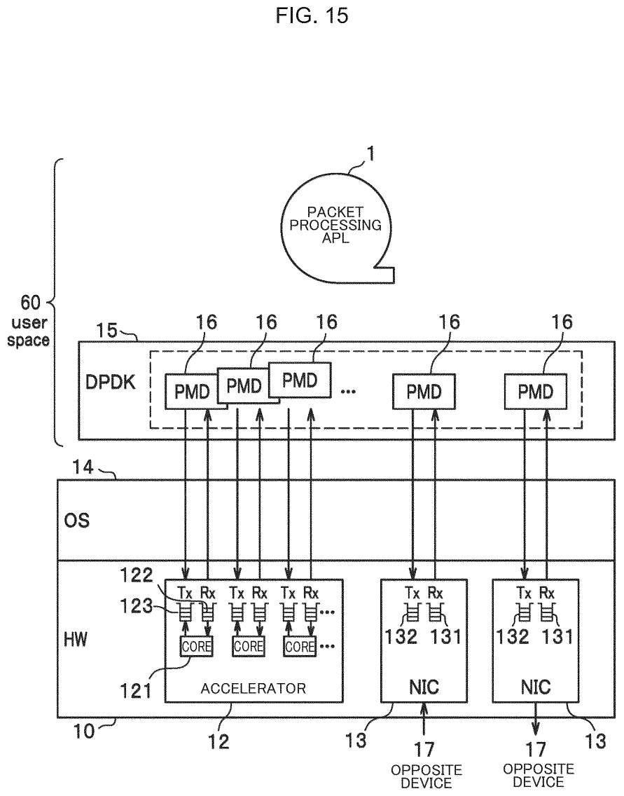

FIG. 9 is a diagram showing an example in which a data transmission system 1000B is applied to an interrupt model in a server virtualization environment with a container configuration. The same components as those in FIGS. 1 and 15 are denoted by the same reference signs.

As shown in FIG. 9, the data transmission system 1000B has a container configuration in which the guest OS 95 in FIG. 8 is replaced with a container 98. The container 98 has a virtual NIC (vNIC).

In a system with a virtual server configuration of a container or the like, data that has arrived at the interface unit can be transmitted to an application in a power-saving and low delay manner.

### Example of Application to Bare Metal Configuration (Non-Virtualized Configuration)

The present invention can be applied to a system having a non-virtualized configuration such as a bare metal configuration. In a non-virtualized system, data that has arrived at the interface unit can be transmitted to an application in a power-saving and low delay manner.

### Scale In/Out

When there is a large amount of traffic and a plurality of NIC devices and NIC ports are used, it is possible to scale in/out the polling threads while controlling the HW interrupt frequency by operating a plurality of polling threads in association with these devices,.

### Extended Technology

According to the present invention, when the number of traffic flows increases, it is possible to scale out the network load by increasing the number of CPUs allocated to the packet arrival monitoring thread in cooperation with receive-side scaling (RSS), which can process inbound network traffic with a plurality of CPUS.

### Application to I/O of PCI Device Such as Accelerator

Although a network interface card (NIC) I/O is illustrated as above, the present technology is also applicable to I/O of PCI devices such as accelerators (FPGA/GPU, etc.). In particular, it can be used for polling when receiving a response results of offload of a forward error correction (FEC) in vRAN to an accelerator.

### Application to Processors Other Than CPU

The present invention is similarly applicable to processors other than CPUs, such as GPUs, FPGAs, and application specific integrated circuits (ASICs), when they have an idle state function.

### Effects

As described above, the on-server data transmission controller 100 (FIGS. 1, 2, and 5) transmits data that has arrived at an interface unit (NIC 13) (FIGS. 1, 2, and 5) to an application (APL 1) (FIGS. 1, 2, and 5) in a user space via an OS, the OS includes a kernel, and a driver (HW interrupt processing unit 182) capable of processing data arrival from the interface unit in a polling mode or an interrupt mode, and the on-server data transmission controller 100 includes: the packet arrival monitoring unit 110 that starts up a thread that monitors arrival of a packet using a polling model in the kernel; and the transmission processing unit 120 that, when the packet arrival monitoring unit 110 detects the arrival of a packet, notifies (reference sign jj in FIGS. 1, 2, and 5) the protocol processing unit 74 in the application of the arriving packet without using a kernel protocol stack (reference sign kk in FIGS. 1, 2, and 5).

In this way, it is possible to avoid context switch overhead, to enable high-speed reflection of settings, and to transmit data that has arrived at an interface unit to an application in a power-saving and low delay manner.

Also, like DPDK, user space applications can select and use the required protocols. In the on-server data transmission controller 100 (FIGS. 1 and 5), a buffer (ring buffer 72, see FIGS. 1 and 5) that stores pointer information indicating a storage destination of the arriving packet is provided in a memory space in a server equipped with the OS, and the transmission processing unit 120 sends the pointer information (reference sign jj in FIG. 5) along with the notification (notification +pointer information) to the protocol processing unit 74.

In this way, because there is no need to distribute the memory address information of the ring buffer 72 between the application and the NIC driver in advance, there is an effect of providing flexibility such as dynamically changing the locations of the ring buffer 72 and the packet buffer 151.

The data transmission system 1000 (FIGS. 1, 2, and 5) includes the on-server data transmission controller 100 (FIGS. 1, 2, and 5) that transmits data that has arrived at an interface unit (NIC 13) (FIGS. 1, 2, and 5) to an application (APL 1, see FIGS. 1, 2, and 5) in a user space via an OS, the protocol processing unit 74 that performs protocol processing of data for the application is provided in the user space, a buffer (ring buffer 72, see FIGS. 2 and 5) indicating a storage destination of an arriving packet is provided on the shared memory 150 (FIGS. 2 and 5) accessible from the protocol processing unit 74, the OS includes a kernel, and a driver (HW interrupt processing unit 182) capable of processing data arrival from the interface unit in a polling mode or an interrupt mode, the on-server data transmission controller 100 includes: the packet arrival monitoring unit 110 that starts up a thread that monitors arrival of a packet using a polling model in the kernel; and the transmission processing unit 120 that, when the packet arrival monitoring unit 110 detects the arrival of a packet, notifies the protocol processing unit 74 (FIGS. 1, 2, and 5) of the presence of the arriving packet without using a kernel protocol stack (reference sign kk in FIGS. 1, 2, and 5), and the protocol processing unit 74 acquires memory address information of the buffer through distribution with the driver, and upon receiving the notification (reference sign jj in FIGS. 1 and 2), refers to the memory address information of the buffer (ring buffer 72, see FIGS. 2 and 5) to obtain pointer information, and acquires the arriving packet (packet buffer 151, see FIG. 2) on the basis of the pointer information.

In this way, by securing a shared memory area such as hugepage in advance between the APL 1 and the NIC driver, and the APL 1 knowing the memory address information of the ring buffer 72 in advance, even if pointer information of the packet is not notified from the polling thread, by referring to the ring buffer 72, it is possible to check the storage destination of the data (payload) of the packet body. As a result, it is possible to avoid context switch overhead, enable high-speed reflection of settings, and transmission data that has arrived at an interface unit to an application in a power-saving and low delay manner.

The data transmission system 1000 (FIGS. 1, 2, and 5) includes the on-server data transmission controller 100 (FIGS. 1, 2, and 5) that transmits data that has arrived at an interface unit to an application (APL 1) (FIGS. 1, 2, and 5) in a user space via an OS, the protocol processing unit 74 (FIGS. 1, 2, and 5) that performs protocol processing of data to the application is provided in the user space, the on-server data transmission controller 100 includes a buffer (ring buffer 72, see FIGS. 2 and 5) indicating a storage destination of an arriving packet on the shared memory 150 (FIGS. 2 and 5) accessible from the protocol processing unit 74, the OS includes a kernel, and a driver (HW interrupt processing unit 182) capable of processing data arrival from the interface unit in a polling mode or an interrupt mode, the on-server data transmission controller 100 includes: the packet arrival monitoring unit (110) that starts up a thread that monitors arrival of a packet using a polling model in the kernel; and the transmission processing unit 120 that, when the packet arrival monitoring unit 110 detects the arrival of a packet, notify the protocol processing unit 74 of the presence of the arriving packet without using a kernel protocol stack (reference sign kk in FIGS. 1, 2, and 5), the transmission processing unit 120 sends pointer information indicating a storage destination of the arriving packet along with the notification to the protocol processing unit 74 (notification+pointer information, see reference sign jj in FIG. 5), and upon receiving the notification, the protocol processing unit 74 acquires the arriving packet (packet buffer 151, see FIG. 5) on the basis of the pointer information sent from the transmission processing unit 120.

As described above, the APL 1 can reach the location of the packet without knowing the location of the ring buffer 72 or the packet buffer 151 in advance. Because there is no need to distribute the memory address information of the ring buffer between the application and the NIC driver in advance, there is an effect of providing flexibility such as dynamically changing the location of the ring buffer 72 and the packet buffer 151.

Note that among the processes described in the above embodiments, all or some of the processes described as being automatically performed can also be manually performed, or all or some of the processes described as being manually performed can also be performed automatically using a known method. In addition, processing procedures, control procedures, specific name, and information including various types of data and parameters illustrated in the specification and the drawings can be arbitrarily changed unless otherwise specified.

In addition, each component of each device that has been illustrated is functionally conceptual one, and may not be necessarily physically configured as illustrated. That is, a specific form of separation and integration of individual devices is not limited to the illustrated form, and all or a part of the configuration can be functionally or physically distributed and integrated in any unit according to various loads, usage conditions, and the like.

Further, some or all of the component, functions, processing units, processing means, and the like described above may be implemented by hardware, for example, by designing them in an integrated circuit. Also, the respective components, functions, and the like may be implemented by software for interpreting and executing a program for causing a processor to implement the respective functions. Information such as a program, a table, and a file for implementing the respective functions can be held in a recording device such as a memory, a hard disk, or a solid state drive (SSD), or in a recording medium such as an integrated circuit (IC) card, a secure digital (SD) card, or an optical disc.

### Reference Signs List

1 Application (APL)
72 Ring buffer (buffer)
74 Protocol processing unit
100 On-server data transmission controller
110 Packet arrival monitoring unit
120 Transmission processing unit
130 Sleep management unit
140 CPU frequency/CPU idle state control unit
150 Shared memory
151 Packet buffer
1000, 1000A, 1000B Data transmission system

1. A non-transitory computer-readable storage medium storing instructions that upon execution, cause a computer to operate as an on-server data transmission controller that transmits data that has arrived at an interface unit to an application in a user space via an operating system (OS),
the OS including
a kernel, and
a driver capable of processing arrival of data from the interface unit in a polling mode or an interrupt mode,
the on-server data transmission controller comprising:
a packet arrival monitoring unit configured to start up a thread that monitors arrival of a packet using a polling model in the kernel; and
a transmission processing unit configured to, when the packet arrival monitoring unit detects the arrival of the packet, notify a protocol processing unit of the application of the packet arriving without using a kernel protocol stack.

2. The non-transitory computer-readable storage medium according to claim 1, wherein
a buffer that stores pointer information indicating a storage destination of the packet arriving is provided in a memory space in a server equipped with the OS, and
the transmission processing unit sends the pointer information along with a notification to the protocol processing unit.

3. A data transmission system comprising an on-server data transmission controller that transmits data that has arrived at an interface unit to an application in a user space via an operating system (OS), wherein
a protocol processing unit configured to perform protocol processing of data to the application is provided in the user space,
a buffer indicating a storage destination of an arriving packet is provided on a shared memory accessible from the protocol processing unit,
the OS includes:
a kernel, and
a driver capable of processing arrival of data from the interface unit in a polling mode or an interrupt mode,
the on-server data transmission controller includes:
a packet arrival monitoring unit configured to start up a thread that monitors arrival of a packet using a polling model in the kernel; and
a transmission processing unit configured to, when the packet arrival monitoring unit detects the arrival of the packet, notify the protocol processing unit of presence of the arriving packet without using a kernel protocol stack, and
the protocol processing unit
acquires memory address information of the buffer with the driver, and
upon receiving a notification, refers to the memory address information to obtain pointer information, and acquires the arriving packet on a basis of the pointer information.

4. A data transmission system comprising an on-server data transmission controller that transmits data that has arrived at an interface unit to an application in a user space via an operating system (OS), wherein
a protocol processing unit configured to perform protocol processing of data to the application is provided in the user space,
a buffer indicating a storage destination of an arriving packet is provided on a shared memory accessible from the protocol processing unit,
the OS includes:
a kernel, and
a driver capable of processing arrival of data from the interface unit in a polling mode or an interrupt mode,
the on-server data transmission controller includes:
a packet arrival monitoring unit configured to start up a thread that monitors arrival of a packet using a polling model in the kernel; and
a transmission processing unit configured to, when the packet arrival monitoring unit detects the arrival of the packet, notify the protocol processing unit of presence of the arriving packet without using a kernel protocol stack,
the transmission processing unit sends pointer information indicating the storage destination of the arriving packet along with notification to the protocol processing unit, and
upon receiving the notification, the protocol processing unit acquires the arriving packet on a basis of the pointer information sent from the transmission processing unit.

5. An on-server data transmission method using an on-server data transmission controller that is implemented by a computer when the computer executes instructions, and transmits data that has arrived at an interface unit to an application in a user space via an operating system (OS),
the OS including
a kernel, and
a driver capable of processing arrival of data from the interface unit in a polling mode or an interrupt mode,
the on-server data transmission method comprising:
a step in which the on-server data transmission controller starts up a thread that monitors arrival of a packet using a polling model in the kernel; and
a transmission processing step in which, when the arrival of the packet is detected, the on-server data transmission controller notifies the application of presence of an arriving packet without using a kernel protocol stack.

6. The on-server data transmission method according to claim 5, wherein
a buffer that stores pointer information indicating a storage destination of the arriving packet is provided in a memory space in a server equipped with the OS, and
in the transmission processing step, the pointer information is sent along with notification to the application.

7. An on-server data transmission method of an on-server data transmission controller that is implemented by a computer when the computer executes instructions, and transmits data that has arrived at an interface unit to an application in a user space via an operating system (OS), wherein
a protocol processing unit configured to perform protocol processing of data to the application is provided in the user space,
a buffer indicating a storage destination of an arriving packet is provided on a shared memory accessible from the protocol processing unit,
the OS includes
a kernel, and
a driver capable of processing arrival of data from the interface unit in a polling mode or an interrupt mode, and
the on-server data transmission method comprises:
a step in which the on-server data transmission controller starts up a thread that monitors arrival of a packet using a polling model in the kernel;
a transmission processing step in which, when the arrival of the packet is detected, the on-server data transmission controller provides notification to the protocol processing unit in the application of the arriving packet without using a kernel protocol stack, and
a step in which the protocol processing unit acquires memory address information of the buffer from the driver, and
upon receiving the notification, refers to the memory address information to obtain pointer information, and acquires the arriving packet on a basis of the pointer information.

8. An on-server data transmission method of an on-server data transmission controller that is implemented by a computer when the computer executes instructions, and transmits data that has arrived at an interface unit to an application in a user space via an operating system (OS), wherein
a protocol processing unit configured to perform protocol processing of data to the application is provided in the user space,
a buffer indicating a storage destination of an arriving packet is provided on a shared memory accessible from the protocol processing unit,
the OS includes:
a kernel, and
a driver capable of processing arrival of data from the interface unit in a polling mode or an interrupt mode, and
the on-server data transmission method comprises:
a step in which the on-server data transmission controller starts up a thread that monitors arrival of a packet using a polling model in the kernel;
a step in which, when the arrival of the packet is detected, the on-server data transmission controller notifies the protocol processing unit of presence of the arriving packet without using a kernel protocol stack, and sends pointer information indicating the storage destination of the arriving packet; and
a step in which, upon receiving notification of the arriving packet, the protocol processing unit acquires the arriving packet on a basis of the pointer information sent from the on-server data transmission controller.

9. (canceled)

10. A device including the computer and the non-transitory computer-readable storage medium storing the instructions according to claim 1.
